(19) United States
(12) Patent Application Publication
(10) Pub. No.: US 2013/0229968 A1
(43) Pub. Date: Sep. 5, 2013

(54) NETWORK CODING IN A CELLULAR COMMUNICATIONS SYSTEM

(71) Applicant: Ahmed Zainaldin, Ottawa (CA)

(72) Inventor: Ahmed Zainaldin, Ottawa (CA)

(73) Assignee: Telefonaktiebolaget L M Ericsson (publ), Stockholm (SE)

(21) Appl. No.: 13/409,749

(22) Filed: Mar. 1, 2012

(51) Int. Cl. H04W 4/06; H04B 7/14

(52) U.S. Cl. 370/312

(57) ABSTRACT

Retransmission of packets in a cellular communications system is disclosed. A network node wirelessly multicasts a first packet and a second packet to each of a first device and a second device. The network node receives a first indication from the first device that the first device did not successfully receive the first packet. The network node receives a second indication from the second device that the second device did not successfully receive the second packet. In response to the first indication and the second indication, the network node network codes the first packet and the second packet to form a network coded packet, and wirelessly multicasts the network coded packet to the first device and the second device in a same time slot.

### FIELD OF THE DISCLOSURE

The present disclosure relates generally to communications systems, and in particular to the use of network coding in cellular communications systems.

### BACKGROUND

Newer generation cellular communications systems, such as 4G systems like 3^{rd} Generation Partnership Project (3GPP) Long Term Evolution (LTE), are being marketed to consumers by service providers as facilitating services that were not possible only a few years ago, such as streaming high-definition video while travelling in a vehicle. As larger numbers of consumers purchase user equipment devices, such as smartphones, service providers may find themselves increasingly unable to deliver a promised quality of service due to dramatically increased demand on bandwidth, leading to customer dissatisfaction. Installing additional hardware, such as base stations, to provide additional bandwidth is expensive and time-consuming, and it cannot be done everywhere all at once. Accordingly, mechanisms for more efficiently exchanging data between devices operating in a cellular communications system would be highly desirable.

### SUMMARY

The present disclosure relates to mechanisms for efficiently exchanging data in a cellular communications system. Such mechanisms involve the use of network coding, which involves applying a network coding function to, for example, first and second packets of data to form a single network coded packet of data. If a receiver of a network coded packet contains a copy of one of the packets encoded in the network coded packet, for example, the first packet, the receiver can use the copy of the first packet in conjunction with a network decoding function to extract the second packet from the network coded packet.

In one embodiment, a network node, such as an eNodeB base station for example, wirelessly multicasts a stream of packets, including a first packet and a second packet, to a plurality of devices, including a first device and a second device. The stream of packets might comprise, for example, a broadcast of a television program. The network node receives a first indication, such as a negative acknowledgment (NACK), from the first device that the first device did not successfully receive the first packet. The network node also receives a second indication from the second device that the second device did not successfully receive the second packet. In response to the first indication and the second indication, the network node network codes the first packet and the second packet to form a network coded packet. The network node then multicasts the network coded packet to the first device and the second device in the same time slot.

The first device and the second device receive the network coded packet, and utilize the successfully received packets to extract from the network coded packet the respective packet that was not received correctly. In particular, the first device uses the second packet to extract the first packet from the network coded packet, and the second device uses the first packet to extract the second packet from the network coded packet.

In one embodiment, prior to sending the network coded packet to the first device, the network node sends a first scheduling message to the first device that indicates that the first packet will be re-multicasted in a subsequent network coded packet. The first scheduling message may also indicate that the network coded packet will be network coded using the first packet and the second packet. Similarly, the network node sends a second scheduling message to the second device that indicates that the second packet will be re-multicasted in the subsequent network coded packet. The second scheduling message may also indicate that the network coded packet will be network coded using the first packet and the second packet.

In another embodiment, a first device, such as an eNodeB base station, exchanges packets with a second device, such as a user equipment device, via a relay network node, such as a picocell node or a femtocell node, for example. The relay network node receives a first scheduling message that directs the relay network node to network code a first packet to be received from the first device with a second packet to be received from the second device. The relay network node receives the first packet and the second packet, and network codes the first packet and the second packet to form a network coded packet.

The relay network node sends the network coded packet to the first device and the second device during a same time slot. The first device and the second device use the respective packet that such device provided to the relay network node to extract the other packet from the network coded packet. In particular, the first device uses the first packet to extract the second packet from the network coded packet, and the second device uses the second packet to extract the first packet from the network coded packet.

The first device may then send a first indication to the relay network node that the network coded packet was received by the first device. The second device may also send a second indication to the relay network node that the network coded packet was received by the second device. In response to receiving the first indication and the second indication, the relay network node may release the first packet and the second packet.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1A is a block diagram illustrating an exemplary process for network coding two packets to form a network coded packet;

FIG. 1B is a block diagram illustrating an exemplary process for network decoding the network coded packet illustrated in FIG. 1A, wherein one packet encoded in the network coded packet is used to extract another packet encoded in the network coded packet;

FIG. 2A is a block diagram illustrating an exemplary relaying of messages between devices in a cellular communications system without the use of network coding;

FIG. 2B is a block diagram illustrating an exemplary relaying of messages between devices in a cellular communications system with the use of network coding;

FIG. 3 is a block diagram illustrating an exemplary cellular communications system in which embodiments of the present disclosure may be practiced;

FIG. 4 is a flowchart illustrating an exemplary process for wireless retransmission of packets in a cellular communications system according to one embodiment;

FIG. 5 is a message flow diagram illustrating an exemplary exchange of messages during a wireless retransmission of packets in a cellular communications system according to one embodiment;

FIG. 6 is a block diagram illustrating an exemplary cellular communications system in which additional embodiments of the present disclosure may be practiced;

FIG. 7 is a flowchart illustrating an exemplary process for the transmission of packets via a relay network node in a cellular communications system according to one embodiment;

FIG. 8 is a message flow diagram illustrating an exemplary exchange of messages during the transmission of packets via a relay network node in a cellular communications system according to one embodiment;

FIG. 9 is a block diagram of an exemplary network node according to one embodiment; and

FIG. 10 is a block diagram of an exemplary user equipment device according to one embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The present disclosure relates generally to the use of network coding of packets in a cellular communications system to more efficiently transmit data and thereby increase throughput. For purposes of illustration, the embodiments will be discussed in the context of a 4G 3^{rd} Generation Partnership Project (3GPP) Long Term Evolution (LTE) cellular communications system, but the embodiments are not limited to any particular type of cellular communications system. The embodiments disclosed herein utilize novel network coding techniques that more efficiently utilize network resources, thereby increasing throughput in a cellular communications system.

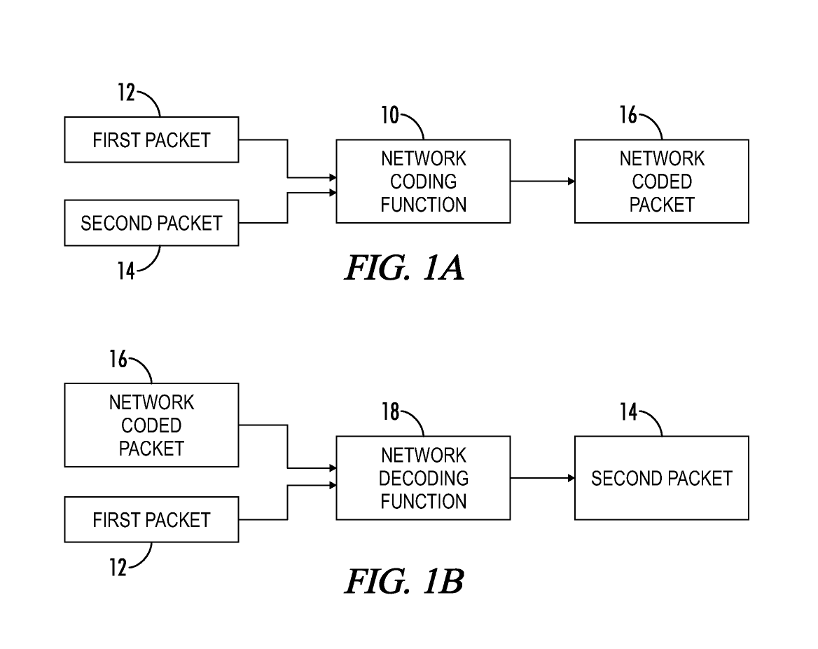

Before delving into the details of the present embodiments, network coding will initially be discussed to provide context for the subsequent discussion of the present embodiments. FIG. 1A is a block diagram illustrating an exemplary process for network coding two packets to form a network coded packet. A network coding function 10 receives, or otherwise inputs, a first packet 12 and a second packet 14. The network coding function 10 then performs an operation on the data in the first packet 12 and the second packet 14 to form a network coded packet 16.

The term “packet” is used herein to refer to any unit of data which the network coding function 10 is capable of inputting in order to network code the unit of data. Thus, a packet may comprise, for example, one or more messages, or one or more sub-units of data, such as one or more Internet Protocol (IP) packets, user datagram packets, or the like. The use of ordinals such as “first” or “second” herein is solely to distinguish elements that otherwise may have similar or identical names, such as the “first packet 12” and the “second packet 14,” and does not imply an importance, priority, or other attribute unless otherwise explicitly stated herein.

The network coding function 10 is typically a logical operation or function, such as an exclusive OR (XOR) function, that operates on the bits of data in the first packet 12 and the second packet 14 to form the network coded packet 16. The network coded packet 16 comprises a fewer number of bits than the total number of bits in both the first packet 12 and the second packet 14, and yet, when properly decoded, both the first packet 12 and the second packet 14 can be extracted from the network coded packet 16. The symbol “0” may be used in the drawings to depict network coded packets. While for purposes of illustration the network coding function 10 is illustrated as network coding two packets, the network coding function 10 is not limited to network coding only two packets, and a greater number of packets may be network coded to thereby form a network coded packet from which each of such greater number of packets may be extracted when properly decoded.

FIG. 1B is a block diagram illustrating an exemplary process for network decoding the network coded packet 16 illustrated in FIG. 1A. In particular, a network decoding function 18 inputs one of the packets that are encoded in the network coded packet 16 to extract the other of the packets that are encoded in the network coded packet 16. In particular, in this example, the network decoding function 18 receives or otherwise inputs the first packet 12 and the network coded packet 16 and extracts from the network coded packet 16 the second packet 14. Although not illustrated, the network decoding function 18 could also input the second packet 14 and the network coded packet 16 to extract the first packet 12 from the network coded packet 16.

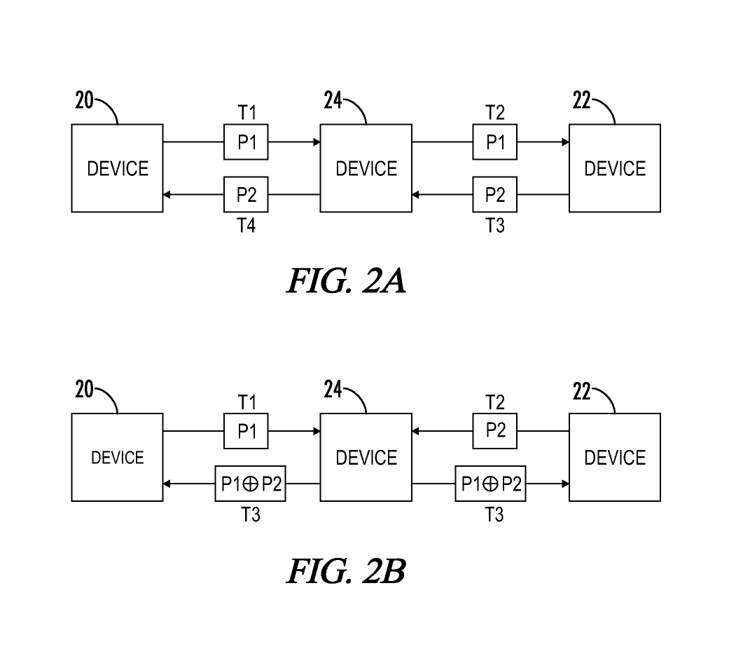

FIG. 2A is a block diagram illustrating an exemplary relaying of messages between devices in a cellular communications system without the use of network coding. Assume that a device 20 desires to send a packet P1 to a device 22 via an intermediate device 24, and that the device 22 desires to transmit a packet P2 to the device 20 via the intermediate device 24. The device 20 may comprise, for example, a network node such as an eNodeB base station; the device 22 may comprise a user equipment (UE) device; and the intermediate device 24 may comprise a relay network node, such as a picocell node or a femtocell node. The term “device,” as used herein, refers to any piece of equipment in a cellular communications system, including, for example, network nodes and relay network nodes that are part of the infrastructure of a cellular communications system, as well as a UE device, such as a smartphone or a digital tablet, that uses the cellular communications system to receive and convey data. In a conventional cellular communications system, the device 20 transmits the packet P1 during a time slot T1 to the intermediate device 24. The intermediate device 24 during a subsequent time slot T2 transmits the packet P1 to the device 22. During the time slot T3, the device 22 transmits the packet P2 to the intermediate device 24. During a subsequent time slot T4, the intermediate device 24 transmits the packet T2 to the device 20. Thus, the relay of information from the device 20 to the device 22 and from the device 22 to the device 20 requires four time slots (i.e., four network resources).

FIG. 2B is a block diagram illustrating an exemplary relaying of messages between devices in a cellular communications system with the use of network coding. Again, assume that the device 20 wishes to provide a packet P1 to the device 22 via an intermediate device 24, and that the device 22 wishes to provide a packet P2 to the device 20 via the intermediate device 24. During a time slot T1, the device 20 sends the packet P1 to the intermediate device 24, and also retains a copy of the packet P1. During a second time slot T2, the device 22 sends the packet P2 to the intermediate device 24, and also retains a copy of the packet P2. The intermediate device 24 then network codes the packets P1 and P2 to form a network coded packet P1⊕P2. The intermediate device 24 can then broadcast, such as by multicasting, the network coded packet P1⊕P2 concurrently to both the device 20 and the device 22 during a same time slot T3. Because the device 20 retained the packet P1, the device 20 can decode the network coded packet P1⊕P2 using the packet P1 to extract the packet P2. Similarly, the device 22 can use the retained packet P2 to decode the network coded packet P1⊕P2 to extract the packet P1 from the network coded packet P1⊕P2. Notably, the transfer of information utilized only three time slots (i.e., three network resources), resulting in a 25% reduction of resources compared to the example illustrated in FIG. 2A. In this manner, network coding can greatly reduce resource allocation in a cellular communications system and thereby increase throughput of such a cellular communications system.

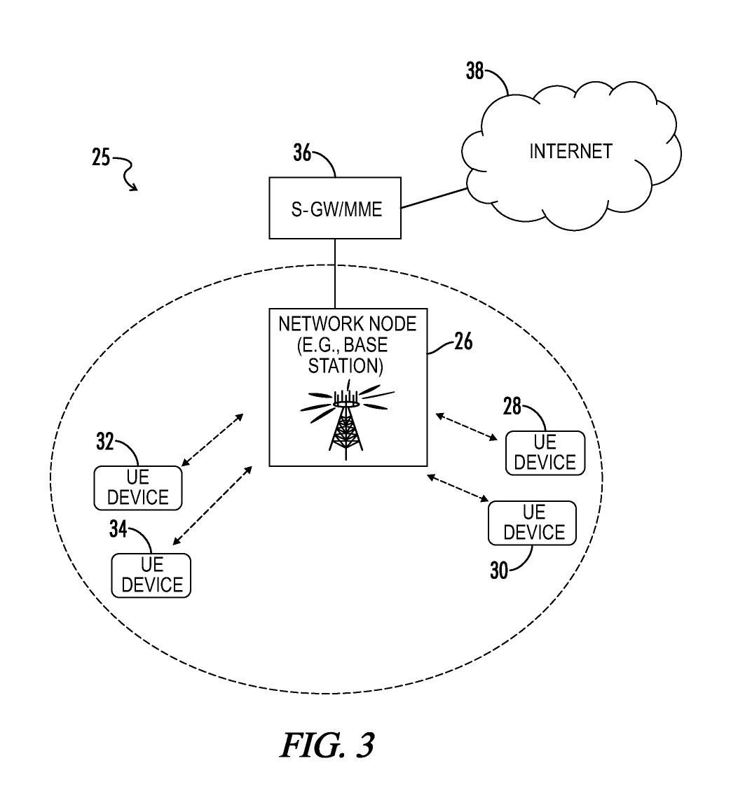

FIG. 3 is a block diagram illustrating an exemplary cellular communications system 25 in which embodiments of the present disclosure may be practiced. The cellular communications system 25 includes a plurality of devices, including a network node 26 and UE devices 28-34. The network node 26 may comprise a base station, such as a 3GPP eNodeB base station, or a femtocell base station such as a 3GPP Home eNodeB (HeNB) base station, or the like. The UE devices 28, 34 may comprise wireless devices capable of receiving data from and transmitting data to the network node 26, such as smartphones, digital computer tablets, laptop computers, or the like. The network node 26 may be communicatively coupled to a serving gateway mobility management entity (S-GW/MME) 36 which provides the network node 26 with access to the Internet 38.

Assume that the network node 26 is multicasting a stream of video packets from the Internet 38 to the UE devices 28 and 30. As used herein, “multicasting” refers to any point-to-multipoint transmission technique wherein multiple receivers can receive a single transmission of data. For example, in the context of a 3GPP cellular communications system 25, point-to-multipoint transmissions may be implemented via the Multimedia Broadcast and Multicast Service (MBMS). As another example, in the context of a 3GPP2 cellular communications system 25, point-to-multipoint transmissions may be implemented via Broadcast and Multicast Service (BCMCS). Accordingly, the network node 26 transmits each video packet once, and each of the UE devices 28, 30 independently receives the video packet, absent a receive error. However, from time to time, either or both of the UE devices 28, 30 may encounter interference and be unable to receive particular packets, or may receive corrupted packets. In this situation, the network node 26 retransmits the particular packets to the affected UE devices 28, 30.

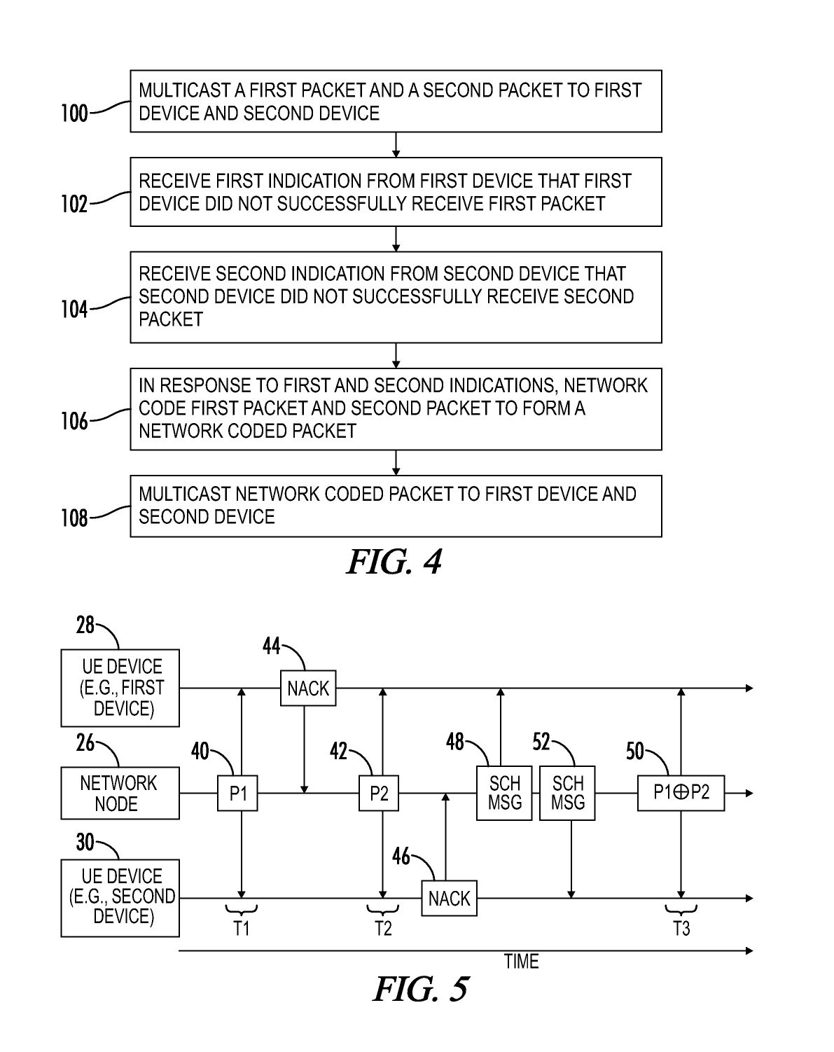

FIG. 4 is a flowchart illustrating an exemplary process for wireless retransmission of packets in the cellular communications system 25 according to one embodiment. FIG. 4 will be discussed in conjunction with FIG. 3. Initially, the network node 26 multicasts a first packet and a second packet of a stream of packets to the UE device 28 (e.g., first device) and the UE device 30 (e.g., second device) (block 100). Assume that the UE device 28 is unable to receive the first packet. Assume further that the UE device 28 did receive the second packet successfully. The UE device 28 sends a first indication, such as a negative acknowledgment (NACK), to the network node 26 that indicates that the UE device 28 did not successfully receive the first packet. Assume further that the UE device 30 receives the first packet successfully, but does not successfully receive the second packet. The UE device 30 transmits a second indication to the network node 26 that the UE device 30 did not successfully receive the second packet. The network node 26 receives the first indication and the second indication (blocks 102, 104). In response to receiving the first and second indications, the network node 26 network codes the first packet and the second packet to form a network coded packet (block 106). The network node 26 then multicasts the network coded packet to the UE device 28 and the UE device 30 (block 108).

The UE device 28 then uses the network coded packet and the successfully received second packet to decode the network coded packet to extract from the network coded packet the first packet. Similarly, the UE device 30 uses the successfully received first packet to extract from the network coded packet the second packet. In this manner, by network coding the first packet and the second packet into a network coded packet and multicasting the network coded packet to both the UE device 28 and the UE device 30 in a same time slot, the cellular communications system 25 utilizes only a single time slot (i.e., one network resource) to provide multiple devices retransmitted packets, as opposed to using multiple time slots (i.e., multiple network resources) for each such retransmitted packets.

FIG. 5 is a message flow diagram illustrating an exemplary exchange of messages during the wireless retransmission of packets in the cellular communications system 25, according to one embodiment. Assume again, as discussed above with regard to FIG. 4, that the network node 26 multicasts a first packet 40 and a second packet 42 to each of the UE device 28 (e.g., first device) and the UE device 30 (e.g., second device). Assume further that the UE device 28 does not properly receive the first packet 40, but does successfully receive the second packet 42. The UE device 28 sends a first indication 44, such as a NACK, to the network node 26 indicating that the UE device 28 did not successfully receive the first packet 40. Assume further that the UE device 30 does not successfully receive the second packet 42, but does successfully receive the first packet 40. The UE device 30 sends a second indication 46 to the network node 26 indicating that the UE device 30 did not successfully receive the second packet 42.

In one embodiment, in response to the first indication 44, the network node 26 sends a first scheduling message 48 to the UE device 28 that indicates that the first packet 40 will be re-multicasted in a network coded packet 50. The first scheduling message 48 may further indicate that the network coded packet 50 will be network coded using the first packet 40 and the second packet 42. The network node 26 sends a second scheduling message 52 to the UE device 30 that indicates that the second packet 42 will be re-multicasted in the network coded packet 50 to the UE device 30. The second scheduling message 52 may further indicate that the network coded packet 50 will be network coded using the first packet 40 and the second packet 42. The network node 26 then wirelessly multicasts the network coded packet 50 to both the UE device 28 and the UE device 30 concurrently during a time slot T3.

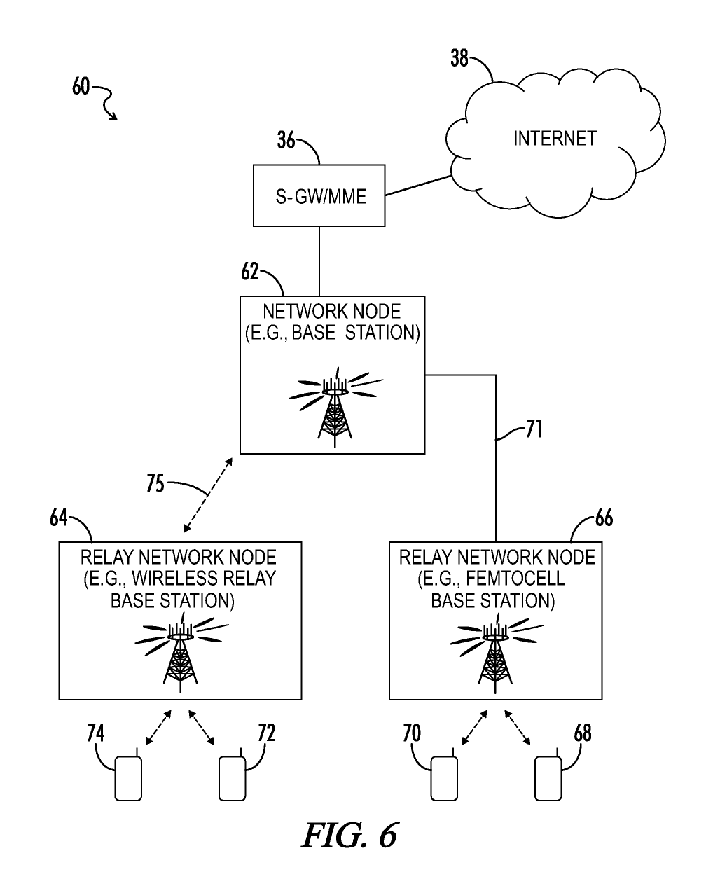

FIG. 6 is a block diagram illustrating an exemplary cellular communications system 60 in which additional embodiments of the present disclosure may be practiced. In this embodiment, the exemplary cellular communications system 60 utilizes network coding in conjunction with an intermediate network node to reduce the number of resource allocations that would otherwise be required to relay messages from one device to another device. In one embodiment, the cellular communications system 60 may comprises a heterogeneous (HetNet) LTE network.

The cellular communications system 60 includes a plurality of devices, including network nodes 62, and relay network nodes 64, 66, as well as UE devices 68, 74. The network node 62 may comprise, for example, an eNodeB base station that communicates with the UE devices 68, 70 via the relay network node 66, which may comprise, for example, a femtocell base station, such as a 3GPP HeNB base station, or the like. A wired communication link 71 may couple the relay network node 66 to the network node 62. While not illustrated, it will be appreciated that the wired communication link 71 may include one or more devices in the path of data between the relay network node 66 and the network node 62, such as routers or the like. The network node 62 may communicate with the UE devices 72, 74 via a relay network node 64, which may comprise, for example, a wireless relay base station. A wireless communication link 75 may couple the relay network node 66 to the network node 62. The S-GW/MME 36 provides the network node 62 with access to the Internet 38.

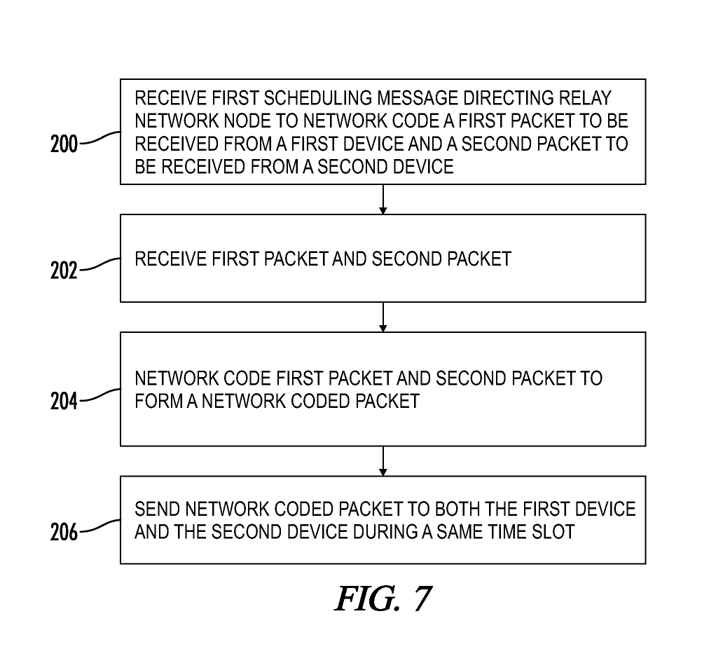

FIG. 7 is a flowchart illustrating an exemplary process for the transmission of packets via the relay network node 66 in the cellular communications system 60 (FIG. 6) according to one embodiment. FIG. 7 will be discussed in conjunction with FIG. 6. Assume that the relay network node 66 receives a first scheduling message that directs the relay network node 66 to network code a first packet to be received from the network node 62 (e.g., first device) and a second packet to be received from the UE device 68 (e.g., second device) (block 200). The relay network node 66 then receives the first packet from the network node 62 and the second packet from the UE device 68 (block 202). The relay network node 66 network codes the first packet received from the network node 62 and the second packet received from the UE device 68 and forms a network coded packet (block 204). The relay network node 66 then sends the network coded packet to both the network node 62 and the UE device 68 during a same time slot (block 206). By sending the first packet in the network coded packet to the UE device 68 while simultaneously sending the second packet in the network coded packet to the network node 62, the relay network node 66 utilizes one fewer time slot than would otherwise be required to communicate such data to the respective devices.

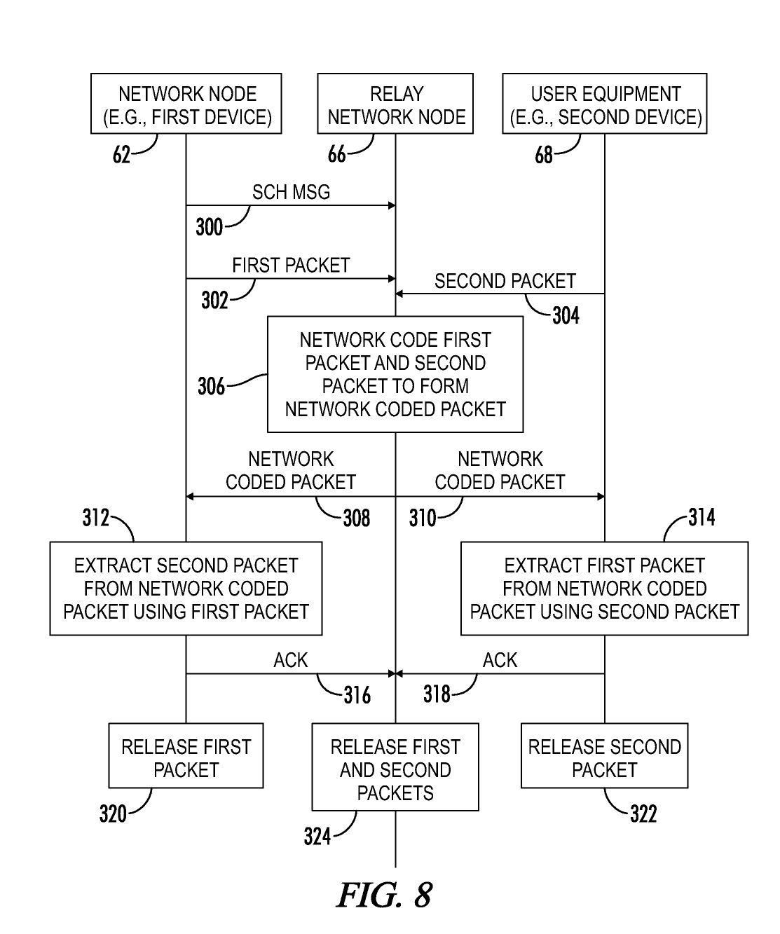

FIG. 8 is a message flow diagram illustrating an exemplary exchange of messages during the transmission of packets via the relay network node 66 in the cellular communications system 60 according to one embodiment. FIG. 8 will be discussed in conjunction with FIG. 6. Initially, the network node 62 (e.g., first device) sends a scheduling message to the relay network node 66 (step 300). The scheduling message may direct the relay network node 66 to network code a subsequent first packet received from the network node 62 with a subsequent second packet received from the UE device 68, and to distribute the resulting network coded packet to the network node 62 and the UE device 68. The network node 62 sends the first packet to the relay network node 66 (step 302). The UE device 68 sends the second packet to the relay network node 66 (step 304). In response to the scheduling message, the relay network node 66 network codes the first packet and the second packet to form a network coded packet (step 306). The relay network node 66 sends the network coded packet to the network node 62 and the UE device 68 in the same time slot (steps 308-310). The network node 62 extracts the second packet from the network coded packet using the first packet (step 312). The UE device 68 extracts the first packet from the network coded packet using the second packet (step 314). The network node 62 sends an indication, such as an acknowledgment (ACK) to the relay network node 66 indicating that the network node 62 has successfully received the network coded packet (step 316). Similarly, the UE device 68 sends an indication to the relay network node 66 that the UE device 68 received the network coded packet (step 318).

Since the network node 62 has successfully extracted the second packet from the network coded packet, the network node 62 can release the first packet (step 320). Similarly, because the UE device 68 has successfully extracted the first packet from the network coded packet, the UE device 68 can release the second packet (step 322). In response to the indications received from the network node 62 and the UE device 68, the relay network node 66 can also safely release the first and second packets (step 324).

In one embodiment, the network node 62 is aware of the time slot in which the UE device 68 will send the second packet to the relay network node 66. The network node 62 schedules the sending of the first packet to the relay network node 66 in the same time slot during which the UE device 68 is scheduled to send the second packet to the relay network node 66. In this embodiment, rather than requiring four time slots to convey the first packet from the network node 62 through the relay network node 66 to the UE device 68, and the second packet from the UE device 68 to the network node 62 through the relay network node 66, only two time slots are required, thus saving 50% of the resources that would otherwise be needed.

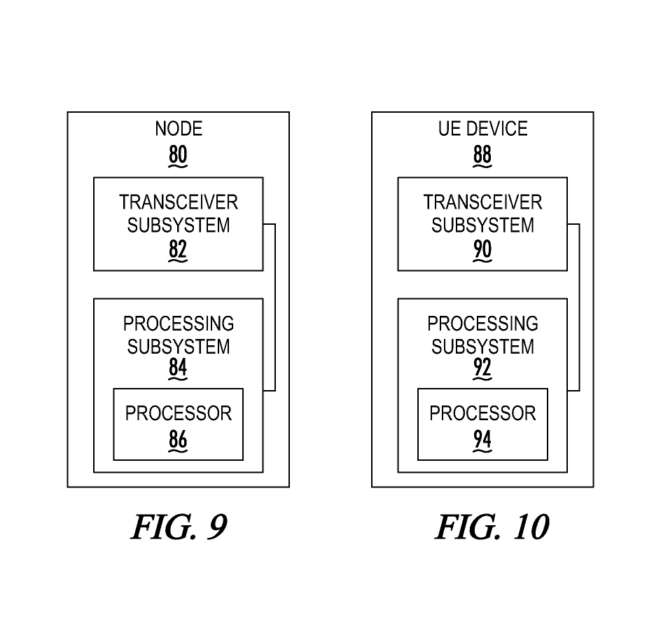

FIG. 9 is a block diagram of an exemplary node 80 suitable for implementing aspects of the embodiments disclosed herein. The node 80 may, for example, implement the network node 26 illustrated in FIG. 3, or implement the network node 62, or relay network nodes 64, 66, illustrated in FIG. 6. The node 80 includes a transceiver subsystem 82 and a processing subsystem 84. The transceiver subsystem 82 generally includes analog and, in some embodiments, digital components for sending and receiving communications to and from UE devices, such as the UE devices 28, 34 (FIG. 1) and the UE devices 68, 74 (FIG. 6) within the wireless coverage area of the node 80, as well as sending and receiving communications to and from other network nodes. From a communications protocol view, the transceiver subsystem 82 may implement at least part of Layer 1 (i.e., the Physical or “PHY” Layer). The processing subsystem 84 generally implements other remaining portions of Layer 1, as well as functions for higher layers in the wireless communications protocol (e.g., Layer 2 (data link layer), Layer 3 (network layer), etc.). Of course, the detailed operation for each of the functional protocol layers, and thus the transceiver subsystem 82 and the processing subsystem 84, will vary depending on both the particular implementation as well as the standard or standards supported by the node 80.

Those skilled in the art will appreciate that the block diagram of the node 80 necessarily omits numerous features that are not necessary to a complete understanding of this disclosure. Although all of the details of the processing subsystem 84 are not illustrated, the processing subsystem 84 comprises one or several general-purpose or special-purpose microprocessors 86 or other microcontrollers programmed with suitable software programming instructions and/or firmware to carry out some or all of the functionality of the network nodes described herein. In addition, or alternatively, the processing subsystem 84 may comprise various digital hardware blocks (e.g., one or more Application Specific Integrated Circuits (ASICs), one or more off-the-shelf digital or analog hardware components, or a combination thereof) configured to carry out some or all of the functionality of the network nodes described herein. The node 80 may also include one or more storage media for storing data necessary and/or suitable for implementing the functionality described herein, as well as for storing programming instructions which, when executed on the microprocessors 86, may implement all or part of the functionality described herein.

FIG. 10 is a block diagram of a UE device 88 suitable for implementing aspects of the embodiments disclosed herein. The UE device 88 may, for example, implement the UE devices 28-34 illustrated in FIG. 3, or the UE devices 68, 74 illustrated in FIG. 6. The UE device 88 may comprise, for example, a cellular telephone such as an Apple® iPhone® smartphone, an Android®-based smartphone, or the like; a computing tablet with cellular capabilities such as an Apple iPad® or the like; a laptop computer with cellular capabilities; or any other processing device capable of communicating wirelessly with a network node, such as the node 80 (FIG. 9). The UE device 88 includes a transceiver subsystem 90 and a processing subsystem 92. The transceiver subsystem 90 generally includes analog and, in some embodiments, digital components for sending and receiving communications to and from base stations, such as the node 80 (FIG. 9). From a communications protocol view, the transceiver subsystem 90 may implement at least part of Layer 1, (i.e., the Physical or “PHY” Layer). The processing subsystem 92 generally implements other remaining portions of Layer 1 as well as functions for higher layers in the wireless communications protocol (e.g., Layer 2 (data link layer), Layer 3 (network layer), etc.). Of course, the detailed operation for each of the functional protocol layers, and thus the transceiver subsystem 90 and the processing subsystem 92, will vary depending on both the particular implementation as well as the standard or standards supported by the UE device 88.

Those skilled in the art will appreciate that the block diagram of the UE device 88 necessarily omits numerous features that are not necessary to a complete understanding of this disclosure. Although all of the details of the processing subsystem 92 are not illustrated, the processing subsystem 92 comprises one or several general-purpose or special-purpose microprocessors 94 or other microcontrollers programmed with suitable software programming instructions and/or firmware to carry out some or all of the functionality of the UE device 88 described herein. In addition, or alternatively, the processing subsystem 92 may comprise various digital hardware blocks (e.g., one or more ASICs, one or more off-the-shelf digital or analog hardware components, or a combination thereof) configured to carry out some or all of the functionality of the UE device 88 described herein. The UE device 88 may also include one or more storage media for storing data necessary and/or suitable for implementing the functionality described herein, as well as for storing programming instructions which, when executed on the microprocessors 94, may implement all or part of the functionality described herein.

The following acronyms are used throughout this disclosure:
3GPP 3rd Generation Partnership Project
ACK Acknowledgment
ASIC Application Specific Integrated Circuit
BCMCS Broadcast and Multicast Service
HeNB Home eNodeB
HetNet Heterogeneous Network
LTE Long Term Evolution
MBMS Multimedia Broadcast and Multicast Service
NACK Negative Acknowledgment
S-GW/MME Serving Gateway Mobility Management Entity
UE User Equipment

Those skilled in the art will recognize improvements and modifications to the preferred embodiments of the present disclosure. All such improvements and modifications are considered within the scope of the concepts disclosed herein and the claims that follow.

What is claimed is:

1. A method for retransmitting packets in a cellular communications system, comprising:
wirelessly multicasting, by a network node, a first packet and a second packet to each of a first device and a second device;
receiving a first indication from the first device that the first device did not successfully receive the first packet;
receiving a second indication from the second device that the second device did not successfully receive the second packet;
in response to the first indication and the second indication, network coding the first packet and the second packet to form a network coded packet; and
wirelessly multicasting the network coded packet to the first device and the second device in a same time slot.

2. The method of claim 1, further comprising:
in response to the first indication, sending a first scheduling message to the first device that indicates that the first packet will be re-multicasted in the network coded packet to the first device.

3. The method of claim 2, wherein the first scheduling message further indicates that the network coded packet will be network coded using the first packet and the second packet.

4. The method of claim 2, further comprising:
sending a second scheduling message to the second device that indicates that the second packet will be re-multicasted in the network coded packet to the second device.

5. The method of claim 4, wherein the second scheduling message further indicates that the network coded packet will be network coded using the first packet and the second packet.

6. The method of claim 1, wherein network coding the first packet and the second packet to form the network coded packet comprises performing a logical operation on the first packet and the second packet to form the network coded packet.

7. A network node, comprising:
a transceiver subsystem configured to communicate with a first device and a second device; and
a processing subsystem coupled to the transceiver subsystem and configured to:
wirelessly multicast a first packet and a second packet to each of the first device and the second device;
receive a first indication from the first device that the first device did not successfully receive the first packet;
receive a second indication from the second device that the second device did not successfully receive the second packet;
in response to the first indication and the second indication, network code the first packet and the second packet to form a network coded packet; and
wirelessly multicast the network coded packet to the first device and the second device in a same time slot.

8. The network node of claim 7, wherein the processing subsystem is further configured to:
in response to the first indication, send a first scheduling message to the first device that indicates that the first packet will be re-multicasted in the network coded packet to the first device.

9. The network node of claim 8, wherein the first scheduling message further indicates that the network coded packet will be network coded using the first packet and the second packet.

10. The network node of claim 8, wherein the processing subsystem is further configured to:
send a second scheduling message to the second device that indicates that the second packet will be re-multicasted in the network coded packet to the second device.

11. The network node of claim 10, wherein the second scheduling message further indicates that the network coded packet will be network coded using the first packet and the second packet.

12. A method for receiving a retransmitted packet, comprising:
receiving, by a first device, a first packet of a multicast stream of packets being multicasted from a network node;
determining, by the first device, that a second packet of the multicast stream of packets was not received by the first device;
sending an indication to the network node that the second packet was not received;
receiving a first scheduling message from the first device that indicates that the second packet will be re-multicasted in a network coded packet;
receiving the network coded packet; and
using the first packet to extract the second packet from the network coded packet.

13. The method of claim 12, wherein the first scheduling message further indicates that the network coded packet will be network coded using the first packet and the second packet.

14. A method of transmitting data in a cellular communications system, comprising:
receiving, by a relay network node, a first scheduling message directing the relay network node to network code a first packet to be received from a first device and a second packet to be received from a second device; receiving, by the relay network node, the first packet and the second packet;
network coding, by the relay network node, the first packet and the second packet to form a network coded packet; and
sending the network coded packet to both the first device and the second device during a same time slot.

15. The method of claim 14, further comprising:
receiving, by the relay network node, a first indication from the first device that the network coded packet was received by the first device;
receiving, by the relay network node, a second indication from the second device that the network coded packet was received by the second device; and
in response to receiving the first indication and the second indication, releasing the first packet and the second packet.

16. The method of claim 14, wherein network coding the first packet and the second packet to form the network coded packet comprises performing a logical operation on the first packet and the second packet to form the network coded packet.

17. The method of claim 14, wherein the relay network node comprises one of a Long Term Evolution (LTE) wireless relay base station and a LTE Home eNodeB base station.

18. The method of claim 14, wherein the first scheduling message is received from the first device, the first device comprising a base station and the second device comprises a user equipment device.

19. The method of claim 14, wherein receiving, by the relay network node, the first packet and the second packet comprises receiving, by the relay network node, the first packet and the second packet during a first time slot.

20. A relay network node, comprising:
a transceiver subsystem configured to communicate with a first device and a second device; and
a processing subsystem coupled to the transceiver subsystem and configured to:
receive a first scheduling message directing the relay network node to network code a first packet to be received from the first device and a second packet to be received from the second device;
receive the first packet and the second packet;
network code the first packet and the second packet to form a network coded packet; and
send the network coded packet to both the first device and the second device during a same time slot.
